(19) United States
(12) Patent Application Publication
(10) Pub. No.: US 2025/0298852 A1
(43) Pub. Date: Sep. 25, 2025

(54) RESIDENTIAL MULTI-FAMILY REAL ESTATE SEARCH ENGINE SYSTEM

(71) Applicant: Kevin Anthony Waters, San Diego, CA (US)

(72) Inventor: Kevin Anthony Waters, San Diego, CA (US)

(21) Appl. No.: 18/611,197

(22) Filed: Mar. 20, 2024

(51) Int. Cl. G06F 16/9535; G06Q 40/03; G06Q 40/06; G06Q 50/16

(52) U.S. Cl. CPC G06F 16/9535; G06Q 40/03; G06Q 40/06; G06Q 50/16

(57) ABSTRACT

A system for multi-family property real estate searches is disclosed, including at least one user computing device in operable connection with a user network. An application server is in operable communication with the user network to host an application system for providing a search engine and investment analysis related to residential multi-family properties. The application system includes a user interface module for providing access to the application system through the user computing device wherein the application program calculates a personal liability unique to each unit of each property and educated by rental data for units rented by a third-party.

### CROSS-REFERENCE TO RELATED APPLICATIONS

The present application claims priority to U.S. Provisional Application No. 63/440,190 filed Jan. 20, 2023, titled “RESIDENTIAL MULTI-FAMILY REAL ESTATE SEARCH ENGINE SYSTEM,” which is hereby incorporated by reference in its entirety.

### TECHNICAL FIELD

The embodiments generally relate to systems and methods for real estate market research and more specifically to a computerized system for providing a multi-family real estate search engine.

### BACKGROUND

Real estate investing involves the purchase, sale, and often the management of real estate in the hopes of realizing a profit on the property. The investment in real estate involves various steps. Often, the real estate agent and/or homebuyer research properties which fit their specific needs. This may include filtering results based off location(s), budget, purpose (e.g., investment, primary residence, or multi-family unit). Multi-family homes are purchased for various reason including the ability for the property owner to live in one unit, while renting the others to offset the cost of their mortgage payment.

Many online systems exist for researching properties for sale. However, no existing platforms work efficiently for searching multi-family homes for homebuyers who are looking to live in and rent out portions of the multi-family property. In the Multiple Listing Service (MLS), the tool realtors use to search for properties has similar drawbacks.

### SUMMARY OF THE INVENTION

This summary is provided to introduce a variety of concepts in a simplified form that is disclosed further in the detailed description of the embodiments. This summary is not intended to identify key or essential inventive concepts of the claimed subject matter, nor is it intended for determining the scope of the claimed subject matter.

The embodiments herein relate to a system for multi-family property real estate searches is disclosed, including at least one user computing device in operable connection with a user network. An application server is in operable communication with the user network to host an application system for providing a search engine and investment analysis related to residential multi-family properties. The application system includes a user interface module for providing access to the application system through the user computing device wherein the application program displays properties which fit a plurality of user criteria and calculates all possible personal liability scenarios for a given property, depending on how many units are in the building and which unit the buyer decides to occupy. Personal liability can be defined as what an owner-occupying multi-family property buyer can expect to pay on a monthly basis after collecting the rental income from the other units. Should the buyer decide not to occupy any of the units, the system will show the overall cash flow and performance of the property.

The system and methods disclosed herein provide an efficient means for searching multi-family properties which are currently listed for sale, while allowing the user to easily filter results based on various parameters. These parameters include filtering by the personal liability (i.e., a net living cost) as well as various additional metrics. The system provides an efficient means for allowing the user to view estimated rental amounts for each unit which comprises the property and determines which unit(s) the user can afford to live in.

The multi-family units which populate the search results within the user interface may include properties which the user would not be able to afford if traditional search methods were used. In previous systems, the user would search for multi-family homes, then manually analyze each property to determine the number of units which comprise the property, manually determine an estimated rental income for each unit using disparate sources, and then manually determine if the property is affordable depending on if the user is living in one unit of the property. The affordability of the property may change based on which unit of the property the user chooses to live in, thus resulting in additional manual analysis by the user.

In one aspect, the system includes a criteria of user database to store a plurality of user criteria including at least one of the following: a location, a unit maximum/minimum, a number of bedrooms, a number of bathrooms, a down payment amount, and a monthly budget.

In one aspect, the property details and search interface further comprises the personal liability cost for each unit and wherein the personal details and search interface displays an indicator representing a qualification status for each rental unit.

In one aspect, the property details and search interface includes provides an input field to permit the user to input a maximum budget, wherein the maximum budget is utilized by the personal liability calculation module to determine the personal liability cost for each rental unit.

In one aspect, the property details and search interface displays a listing of rental units comprising the multi-family property.

In one aspect, the property details and search interface provides a filter to permit the user to search using a location, a price, a maximum budget, a number of beds, and a number of baths.

In one aspect, the computer system further comprises a processor to perform various steps, including receiving, via a user input, a monthly budget, a down payment amount, an income amount, and a debt amount. An allowable mortgage calculation module then generates the maximum mortgage amount. A user then inputs a plurality of user inputs including at least one of the following: the monthly budget amount, a desired number of bedrooms, a desired number of bathrooms, and a desired square footage. The property module then analyzes an MLS to identify and aggregate one or more multi-family properties which meet the plurality of user inputs. The allowable offer calculation module may then generate the maximum allowable offer for each of the multi-family properties. Each of the multi-family properties is then filtered to display the multi-family properties which the user qualifies for based on the plurality of user inputs and the maximum allowable offer.

In one aspect, a third-party database provides a plurality of rental property data to permit the comparison of a current rent amount versus a market rate amount.

Other illustrative variations within the scope of the invention will become apparent from the detailed description provided hereinafter. The detailed description and enumerated variations, while disclosing optional variations, are intended for purposes of illustration only and are not intended to limit the scope of the invention.

### BRIEF DESCRIPTION OF THE DRAWINGS

A complete understanding of the present embodiments and the advantages and features thereof will be more readily understood by reference to the following detailed description when considered in conjunction with the accompanying drawings wherein:

FIG. 1 illustrates a block diagram of a computing system, according to some embodiments;

FIG. 2 illustrates a block diagram of a computing system and an application program, according to some embodiments;

FIG. 3 illustrates a block diagram of databases and application program, according to some embodiments;

FIG. 4 illustrates a flowchart of the property display process, according to some embodiments;

FIG. 5 illustrates a screenshot of the property search interface, according to some embodiments;

FIG. 6 illustrates a screenshot of the property display interface, according to some embodiments;

FIG. 7 illustrates a screenshot of the property payment details interface, according to some embodiments;

FIG. 8 illustrates a screenshot of the property details interface, according to some embodiments;

FIG. 9 illustrates a table displaying an exemplary personal liability calculation chart for a 3-unit property, according to some embodiments; and

FIG. 10 illustrates a flowchart of the process for filtering and displaying available properties, according to some embodiments;

FIG. 11 illustrates the Unique Filtering System for Displaying Properties Based on Max Allowable Offer, according to some embodiments;

FIG. 12 illustrates how rental income influences a homebuyer's Total Borrowing Power, which in turn influences a given buyer's Total Purchasing Power, according to some embodiments;

FIG. 13 illustrates Debt-to-Income Ratio and its Relationship to a Homebuyer's “Total Borrowing Power”, according to some embodiments; and

FIG. 14 illustrates a screenshot of the property listings and search interface, according to some embodiments.

### DETAILED DESCRIPTION

The specific details of the single embodiment or variety of embodiments described herein are to the described system and methods of use. Any specific details of the embodiments are used for demonstration purposes only, and no unnecessary limitations or inferences are to be understood thereon.

Before various example embodiments are described in detail, it is noted that the embodiments reside primarily in combinations of components and procedures related to systems. Accordingly, system components have been represented, where appropriate, by conventional symbols in the drawings, showing only those specific details that are pertinent to understanding the embodiments of the present disclosure so as not to obscure the disclosure with details that will be readily apparent to those of ordinary skill in the art having the benefit of the description herein.

In this disclosure, the various embodiments may be systems, methods, and/or computer program products at any possible technical detail level of integration. A computer program product can include, among other things, a computer-readable storage medium having computer- readable program instructions thereon for causing a processor to carry out aspects of the present disclosure.

In general, the embodiments described herein relate to a system and method for searching for multi-family homes with the intent of purchasing the home to live in one unit while renting the other units to third-parties. This can be described as an owner-occupying “house-hacker” as is more clearly defined below. The system may also be used by a homebuyer who will not live in the property to access information related to the overall cash flow of the property. The system first displays all residential multi-family homes using data pulled from the MLS/other sources. From there, an estimated total monthly mortgage payment (TMP) is calculated for each property, based on various assumptions (e.g., 20% down payment, today's interest rate, duration of mortgage, etc.) and predetermined factors (e.g., list price of property, property tax rate of location, etc.).

The system then calculates and displays a “personal liability” unique to each unit of a given property, for every property on the platform. Duplexes will have 2 personal liabilities (as there are 2 units); triplexes will have 3 personal liabilities, and quadplexes will have 4 personal liabilities. Regardless of which unit the homebuyer chooses to live in, the total monthly mortgage payment does not change. However, the amount of rental income the homebuyer will receive will vary depending on which unit the homebuyer decides to occupy.

The term “personal liability”, as used herein, is to be synonymous with a “net living cost”. Each term may be used interchangeably throughout the embodiments described herein.

Rental income produced is based on rental rates of individual units which is determined by data pulled from the MLS for units currently occupied, as well as historical rental data from a service such as Rentometer.com. If the unit(s) is/are vacant, the system may determine an expected rental amount (also using a service like Rentometer.com). “Personal liability” is simply the total monthly mortgage payment, less the rental income produced from the other unit(s) that the homeowner is not occupying. Displaying all personal liabilities provides a convenient means for finding multi-family homes and viewing monthly payment options for each unit, as the homeowner can filter by a comfortable monthly budget. The system will display properties where at least one of the personal liabilities is less than or equal to the user's comfortable monthly budget, despite the possibility of other personal liabilities within the same property exceeding the user's comfortable monthly budget. The user may then make an informed decision on buying, renting out, and living in the property they plan to purchase. In such, Users of App can search for properties using a “personal liability,” rather than purchase price.

As used herein, the term “Personal Liability Filter” is used to describe a filter which allows the user to shop for owner occupied residential multi-family properties based on their monthly budget, rather than the purchase price of the property. The Personal Liability Filter may also help realtors much more efficiently find properties that will fit their client's needs.

As used herein, the term “house-hacker” or “house-hacking” refers to when a home buyer wants to purchase multi-family property to live in one unit, while renting out the other unit(s) to reduce (or even cover entirely) the cost of the monthly mortgage payment. In some cases, the home buyer may profit while living in the property.

As used herein, the term “investor” refers to when a home buyer is purchasing the property as a non-occupant. In such cases the system will calculate overall cash flow and other performance metrics related to investing instead of personal liability, as personal liability only applies to a house-hacker.

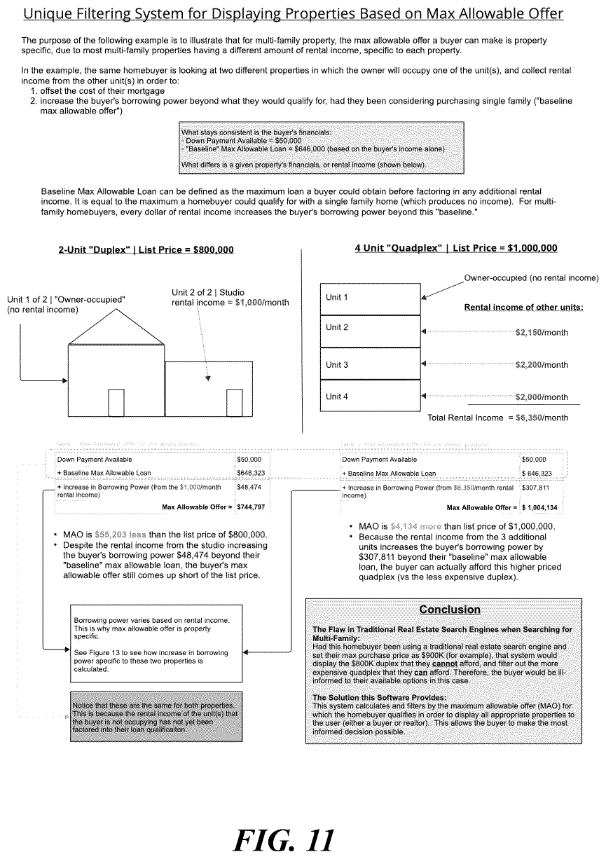

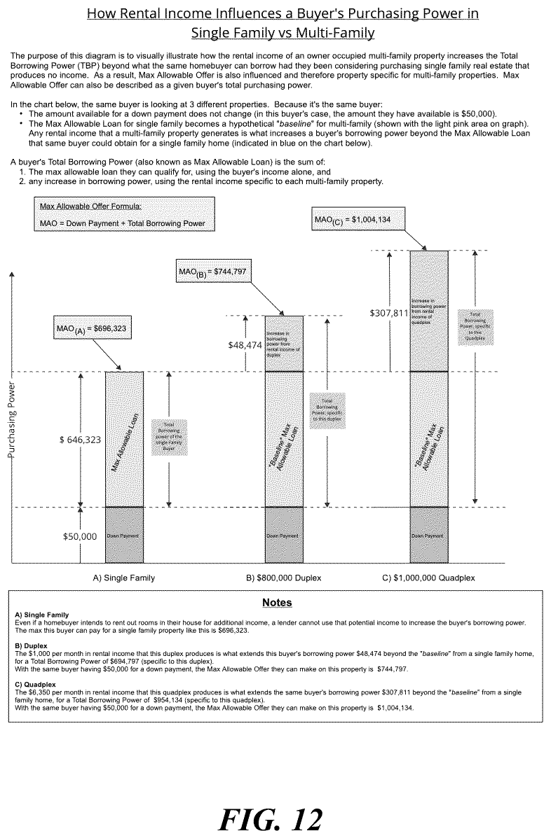

In some embodiments, the system calculates and filters by the maximum allowable offer (MAO) for which the homebuyer qualifies in order to display all appropriate properties to the user (either a buyer or realtor). MAO for multi-family is most easily comprehended when first understanding how MAO works for single family. This concept is illustrated in FIGS 11-12 and described below.

### MAO for Single Family (The Concept)

For single family homes, the MAO is simply the buyer's maximum allowable mortgage (calculated based on the buyer's net income) plus the buyer's cash-to-close available, which is defined as the down payment and closing costs required to purchase a given property. This MAO is essentially a single family homebuyer's maximum pre-approval amount to purchase a single family residence.

### MAO for multifamily (The Concept)

Purchasing a multi-family property is much different than purchasing a single family home. This is because when purchasing multi-family, you are not only purchasing real estate, but also additional income rental stream(s). The additional income streams (the rental income from the other units) positively affects the amount of mortgage the borrower can qualify for. The more income from the other units, the more the borrower can qualify for (See FIG. 12 to view how rental income increases the Total Borrowing Power for a given buyer).

The MAO for multifamily initially follows the same process for qualification as single family to establish a “baseline” qualification amount. The “baseline” qualification amount for multifamily is always equal to the max allowable offer for a single family home (See FIG. 12).

However, with multi-family homes, the MAO differs for each individual property because the rental income of units of a given property affects the buyer's net income. The more rental income a property generates, the more the buyer's purchasing power increases beyond the “baseline” (see FIGS 11-12).

Users of this Platform can enter an estimated monthly net income and cash-to-close amount that the buyer has available to establish the buyer's baseline qualification amount (see FIGS 11- 12). Any rental income that a given multifamily property produces will extend the buyer's purchasing power beyond this baseline amount.

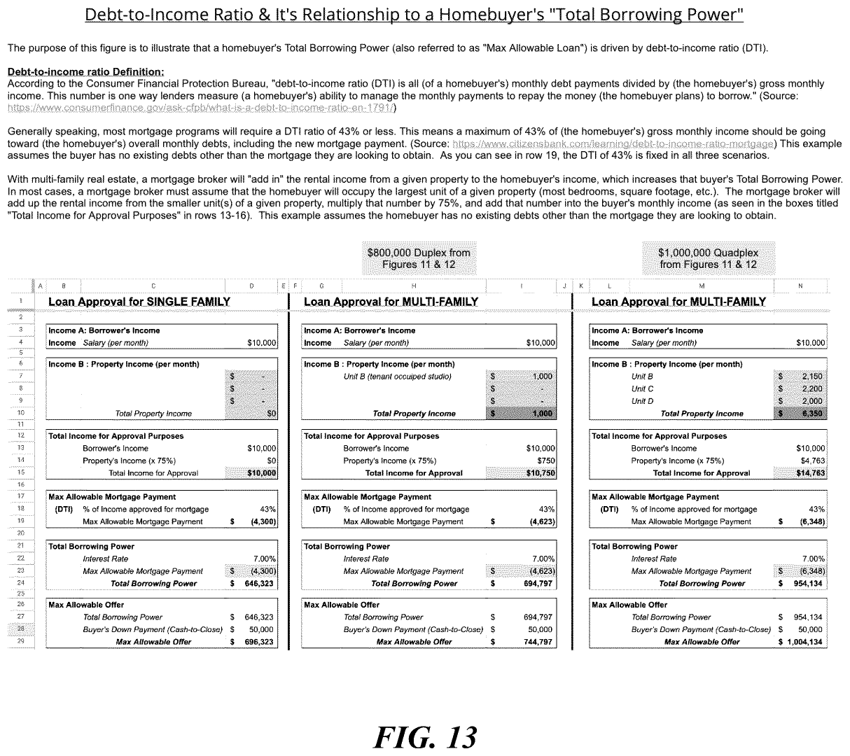

Referring to FIG. 13, with multi-family real estate, a mortgage broker will “add in” the rental income from a given property to the homebuyer's income, which increases that buyer's Total Borrowing Power. In most cases, a mortgage broker must assume that the homebuyer will occupy the largest unit of a given property (most bedrooms, square footage, etc.). The mortgage broker will add up the rental income from the smaller unit(s) of a given property, multiply that number by 75%, and add that number into the buyer's monthly income (as seen in the boxes titled “Total Income for Approval Purposes” in rows 13-16).

### The Math of MAO for Multi-Family

To calculate a multi-family homebuyer's qualification beyond their baseline (for a given property), the system takes into account the rental income of the units the borrower will not occupy and adds this to the borrower's net income to determine a maximum allowable offer (MAO) specific to that property. Unlike in single family purchasing where the MAO is a fixed amount dependent only on the borrower's income, in multi-family purchasing the MAO is property specific, influenced by both 1) the borrower's income and 2) the amount of rental income an individual property may generate. Because virtually every single multi-family property has a different rental income specific to the individual units of that property, that means that qualification for multi-family property is specific to each individual property on the market. Taking the above into consideration, if the MAO for a given property is greater than or equal to the list price, that particular property shall be displayed to the User. This allows a buyer to view a complete list of all properties they could potentially purchase.

### Example of Max Allowable Offer Filtering

This is especially useful when looking at the following example (from FIG. 11), which illustrates how the MAO is property specific, and how a buyer is able to purchase a $1,000,000 quadplex (as a result of its higher rental income), while the same buyer is unable to purchase an $800,000 duplex (as a result of its lower rental income). In this example, you can see that the buyer's MAO for a less expensive property (the $800K duplex) is $744,797, which is less than the list price. The MAO for a more expensive property (the $1,000,000 quadplex) is $1,004,134, which is greater than the list price. Despite the list price being $200K higher on the quadplex than the duplex, the buyer is able to purchase this more expensive quadplex as a result of its higher rental income. Therefore, the system would filter out the less expensive duplex that the buyer cannot purchase, while showing the user the more expensive quadplex that they can purchase.

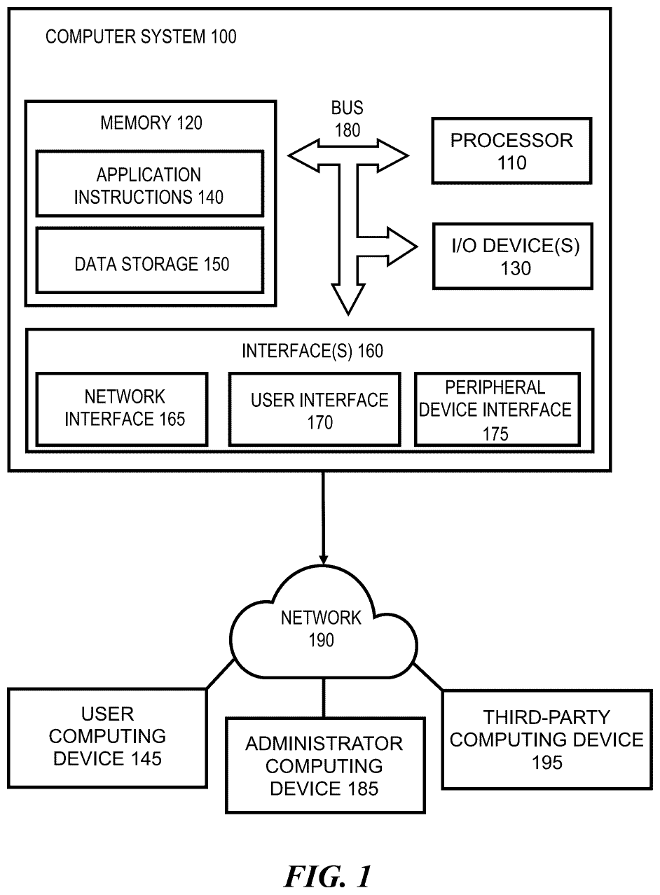

FIG. 1 illustrates an example of a computer system 100 that may be utilized to execute various procedures, including the processes described herein. The computer system 100 comprises a standalone computer or mobile computing device, a mainframe computer system, a workstation, a network computer, a desktop computer, a laptop, or the like. The computing device 100 can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive).

In some embodiments, the computer system 100 includes one or more processors 110 coupled to a memory 120 through a system bus 180 that couples various system components, such as an input/output (I/O) devices 130, to the processors 110. The bus 180 may be any of several types of bus structures including a memory bus or memory controller, a peripheral bus, and a local bus using any of a variety of bus architectures. For example, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus, also known as Mezzanine bus.

In some embodiments, the computer system 100 includes one or more input/output (I/O) devices 130, such as video device(s) (e.g., a camera), audio device(s), and display(s) are in operable communication with the computer system 100. In some embodiments, similar I/O devices 130 may be separate from the computer system 100 and may interact with one or more nodes of the computer system 100 through a wired or wireless connection, such as over a network interface.

Processors 110 suitable for the execution of computer readable program instructions include both general and special purpose microprocessors and any one or more processors of any digital computing device. For example, each processor 110 may be a single processing unit or a number of processing units and may include single or multiple computing units or multiple processing cores. The processor(s) 110 can be implemented as one or more microprocessors, microcomputers, microcontrollers, digital signal processors, central processing units, state machines, logic circuitries, and/or any devices that manipulate signals based on operational instructions. For example, the processor(s) 110 may be one or more hardware processors and/or logic circuits of any suitable type specifically programmed or configured to execute the algorithms and processes described herein. The processor(s) 110 can be configured to fetch and execute computer readable program instructions stored in the computer-readable media, which can program the processor(s) 110 to perform the functions described herein.

In this disclosure, the term “processor” can refer to substantially any computing processing unit or device, including single-core processors, single-processors with software multithreading execution capability, multi-core processors, multi-core processors with software multithreading execution capability, multi-core processors with hardware multithread technology, parallel platforms, and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, or any combination thereof designed to perform the functions described herein. Further, processors can exploit nano-scale architectures, such as molecular and quantum- dot based transistors, switches, and gates, to optimize space usage or enhance performance of user equipment. A processor can also be implemented as a combination of computing processing units.

In some embodiments, the memory 120 includes computer-readable application instructions 150, configured to implement certain embodiments described herein, and a database 150, comprising various data accessible by the application instructions 140. In some embodiments, the application instructions 140 include software elements corresponding to one or more of the various embodiments described herein. For example, application instructions 140 may be implemented in various embodiments using any desired programming language, scripting language, or combination of programming and/or scripting languages (e.g., Android, C, C++, C #, JAVA, JAVASCRIPT, PERL, etc.).

In this disclosure, terms “store,” “storage,” “data store,” “data storage,” “database,” and substantially any other information storage component relevant to operation and functionality of a component are utilized to refer to “memory components,” which are entities embodied in a “memory,” or components comprising a memory. Those skilled in the art would appreciate that the memory and/or memory components described herein can be volatile memory, nonvolatile memory, or both volatile and nonvolatile memory. Nonvolatile memory can include, for example, read only memory (ROM), programmable ROM (PROM), electrically programmable ROM (EPROM), electrically erasable ROM (EEPROM), flash memory, or nonvolatile random access memory (RAM) (e.g., ferroelectric RAM (FeRAM). Volatile memory can include, for example, RAM, which can act as external cache memory. The memory and/or memory components of the systems or computer-implemented methods can include the foregoing or other suitable types of memory.

Generally, a computing device will also include, or be operatively coupled to receive data from or transfer data to, or both, one or more mass data storage devices; however, a computing device need not have such devices. The computer readable storage medium (or media) can be a tangible device that can retain and store instructions for use by an instruction execution device. The computer readable storage medium can be, for example, an electronic storage device, a magnetic storage device, an optical storage device, an electromagnetic storage device, a semiconductor storage device, or any suitable combination of the foregoing. A non-exhaustive list of more specific examples of the computer readable storage medium can include: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. In this disclosure, a computer readable storage medium is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

In some embodiments, the steps and actions of the application instructions 140 described herein are embodied directly in hardware, in a software module executed by a processor, or in a combination of the two. A software module may reside in RAM, flash memory, ROM memory, EPROM memory, EEPROM memory, registers, a hard disk, a removable disk, a CD-ROM, or any other form of storage medium known in the art. An exemplary storage medium may be coupled to the processor 110 such that the processor 110 can read information from, and write information to, the storage medium. In the alternative, the storage medium may be integrated into the processor 110. Further, in some embodiments, the processor 110 and the storage medium may reside in an Application Specific Integrated Circuit (ASIC). In the alternative, the processor and the storage medium may reside as discrete components in a computing device. Additionally, in some embodiments, the events or actions of a method or algorithm may reside as one or any combination or set of codes and instructions on a machine-readable medium or computer-readable medium, which may be incorporated into a computer program product.

In some embodiments, the application instructions 140 for carrying out operations of the present disclosure can be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The application instructions 140 can execute entirely on the user's computer, partly on the user's computer, as a stand-alone software package, partly on the user's computer and partly on a remote computer, or entirely on the remote computer or server. In the latter scenario, the remote computer can be connected to the user's computer through any type of network, including a local area network (LAN) or a wide area network (WAN), or the connection can be made to an external computer (for example, through the Internet using an Internet Service Provider). In some embodiments, electronic circuitry including, for example, programmable logic circuitry, field-programmable gate arrays (FPGA), or programmable logic arrays (PLA) can execute the computer readable program instructions by utilizing state information of the computer readable program instructions to personalize the electronic circuitry, in order to perform aspects of the present disclosure.

In some embodiments, the application instructions 140 can be downloaded to a computing/processing device from a computer readable storage medium, or to an external computer or external storage device via a network 190. A network adapter card or network interface in each computing/processing device receives computer readable program instructions from the network and forwards the computer readable application instructions 140 for storage in a computer readable storage medium within the respective computing/processing device.

In some embodiments, the computer system 100 includes one or more interfaces 160 that allow the computer system 100 to interact with other systems, devices, or computing environments. In some embodiments, the computer system 100 comprises a network interface 165 to communicate with a network 190. In some embodiments, the network interface 165 is configured to allow data to be exchanged between the computer system 100 and other devices attached to the network 190, such as other computer systems, or between nodes of the computer system 100. In various embodiments, the network interface 165 may support communication via wired or wireless general data networks, such as any suitable type of Ethernet network, for example, via telecommunications/telephony networks such as analog voice networks or digital fiber communications networks, via storage area networks such as Fiber Channel SANs, or via any other suitable type of network and/or protocol. Other interfaces include the user interface 170 and the peripheral device interface 175.

In some embodiments, the network 190 corresponds to a local area network (LAN), wide area network (WAN), the Internet, a direct peer-to-peer network (e.g., device to device Wi-Fi, Bluetooth, etc.), and/or an indirect peer-to-peer network (e.g., devices communicating through a server, router, or other network device). The network 190 can comprise copper transmission cables, optical transmission fibers, wireless transmission, routers, firewalls, switches, gateway computers and/or edge servers. The network 190 can represent a single network or multiple networks. In some embodiments, the network 190 used by the various devices of the computer system 100 is selected based on the proximity of the devices to one another or some other factor. For example, when a first user device and second user device are near each other (e.g., within a threshold distance, within direct communication range, etc.), the first user device may exchange data using a direct peer-to-peer network. But when the first user device and the second user device are not near each other, the first user device and the second user device may exchange data using a peer-to-peer network (e.g., the Internet). The Internet refers to the specific collection of networks and routers communicating using an Internet Protocol (“IP”) including higher level protocols, such as Transmission Control Protocol/Internet Protocol (“TCP/IP”) or the Uniform Datagram Packet/Internet Protocol (“UDP/IP”).

Any connection between the components of the system may be associated with a computer-readable medium. For example, if software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. As used herein, the terms “disk” and “disc” include compact disc (CD), laser disc, optical disc, digital versatile disc (DVD), floppy disk, and Blu-ray disc; in which “disks” usually reproduce data magnetically, and “discs” usually reproduce data optically with lasers. Combinations of the above should also be included within the scope of computer-readable media. In some embodiments, the computer-readable media includes volatile and nonvolatile memory and/or removable and non-removable media implemented in any type of technology for storage of information, such as computer-readable instructions, data structures, program modules, or other data. Such computer-readable media may include RAM, ROM, EEPROM, flash memory or other memory technology, optical storage, solid state storage, magnetic tape, magnetic disk storage, RAID storage systems, storage arrays, network attached storage, storage area networks, cloud storage, or any other medium that can be used to store the desired information and that can be accessed by a computing device. Depending on the configuration of the computing device, the computer-readable media may be a type of computer-readable storage media and/or a tangible non-transitory media to the extent that when mentioned, non-transitory computer-readable media exclude media such as energy, carrier signals, electromagnetic waves, and signals per se.

In some embodiments, the system is world-wide-web (www) based, and the network server is a web server delivering HTML, XML, etc., web pages to the computing devices. In other embodiments, a client-server architecture may be implemented, in which a network server executes enterprise and custom software, exchanging data with custom client applications running on the computing device.

In some embodiments, the system can also be implemented in cloud computing environments. In this context, “cloud computing” refers to a model for enabling ubiquitous, convenient, on-demand network access to a shared pool of configurable computing resources (e.g., networks, servers, storage, applications, and services) that can be rapidly provisioned via virtualization and released with minimal management effort or service provider interaction, and then scaled accordingly. A cloud model can be composed of various characteristics (e.g., on-demand self-service, broad network access, resource pooling, rapid elasticity, measured service, etc.), service models (e.g., Software as a Service (“SaaS”), Platform as a Service (“PaaS”), Infrastructure as a Service (“IaaS”), and deployment models (e.g., private cloud, community cloud, public cloud, hybrid cloud, etc.).

As used herein, the term “add-on” (or “plug-in”) refers to computing instructions configured to extend the functionality of a computer program, where the add-on is developed specifically for the computer program. The term “add-on data” refers to data included with, generated by, or organized by an add-on. Computer programs can include computing instructions, or an application programming interface (API) configured for communication between the computer program and an add-on. For example, a computer program can be configured to look in a specific directory for add-ons developed for the specific computer program. To add an add-on to a computer program, for example, a user can download the add-on from a website and install the add-on in an appropriate directory on the user's computer.

In some embodiments, the computer system 100 may include a user computing device 145, an administrator computing device 185 and a third-party computing device 195 each in communication via the network 190. The user computing device 145 may be utilized a user (e.g., a healthcare provider) to interact with the various functionalities of the system including to perform patient rounds, handoff patient rounding responsibility, perform biometric verification tasks, and other associated tasks and functionalities of the system. The administrator computing device 185 is utilized by an administrative user to moderate content and to perform other administrative functions. The third-party computing device 195 may be utilized by third parties to receive communications from the user computing device, transmit communications to the user via the network, and otherwise interact with the various functionalities of the system.

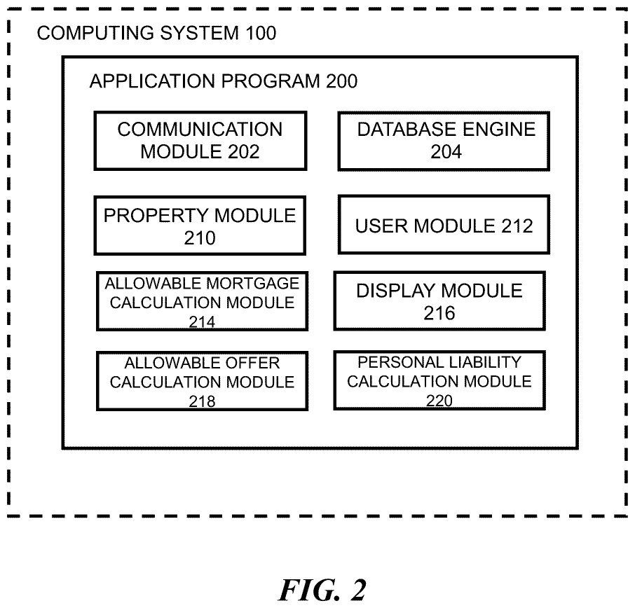

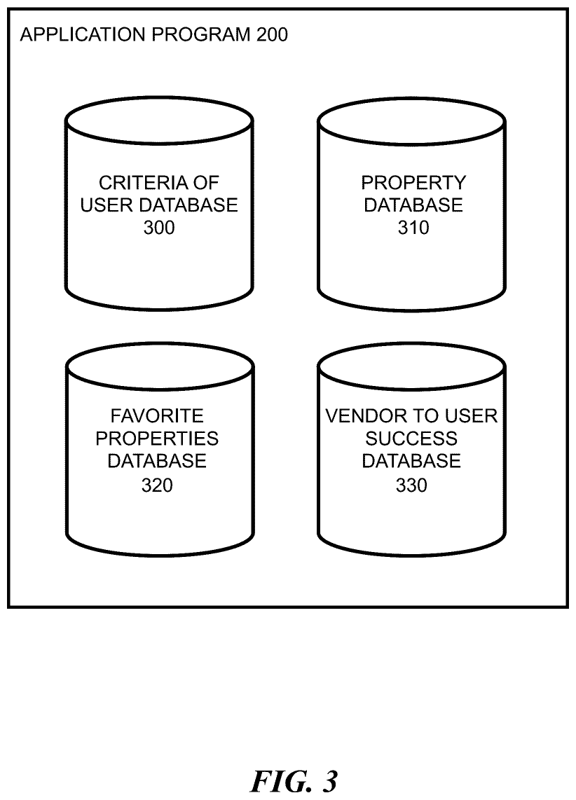

FIGS. 2 and 3 illustrate an example computer architecture for the application program 200 operated via the computing system 100. The computer system 100 comprises several modules and engines configured to execute the functionalities of the application program 200, and a database engine 204 configured to facilitate how data is stored and managed in one or more databases. In particular, FIG. 2 is a block diagram showing the modules and engines needed to perform specific tasks within the application program 200, and FIG. 3 is a block diagram showing the various databases utilized by the various modules.

Referring to FIG. 2, the computing system 100 operating the application program 200 comprises one or more modules having the necessary routines and data structures for performing specific tasks, and one or more engines configured to determine how the platform manages and manipulates data. In some embodiments, the application program 200 comprises one or more of a communication module 202, a database engine 204, a property module 210, a user module 212, an allowable mortgage calculation module 214, a display module 216, an allowable offer calculation module 218, and a final mortgage calculation module 220.

In some embodiments, the communication module 202 is configured for receiving, processing, and transmitting a user command and/or one or more data streams. In such embodiments, the communication module 202 performs communication functions between various devices, including the user computing device 145, the administrator computing device 185, and a third-party computing device 195. In some embodiments, the communication module 202 is configured to allow one or more users of the system, including a third-party, to communicate with one another. In some embodiments, the communications module 202 is configured to maintain one or more communication sessions with one or more servers, the administrative computing device 185, and/or one or more third-party computing device(s) 195.

In some embodiments, the communication module 202 may allow the user to communicate with realtors, lenders, cost segregation experts, tax attorneys, accountants, etc. which are commonly involved in the home buying process.

In some embodiments, a database engine 204 is configured to facilitate the storage, management, and retrieval of data to and from one or more storage mediums, such as the one or more internal databases described herein. In some embodiments, the database engine 204 is coupled to an external storage system. In some embodiments, the database engine 204 is configured to apply changes to one or more databases. In some embodiments, the database engine 204 comprises a search engine component for searching through thousands of data sources stored in different locations.

The database engine 204 may be in communication with a home listing service, MLS, or other databases wherein data related to homes for sale are stored. The database engine 204 facilitates the retrieval of multi-home property data which can be used by the system for the various functionalities described herein.

In some embodiments, the property module 210 is in operable communication with the computing device to determine multi-home properties which are available for purchase. The property module 210 may aid in the indication of property information including purchase price, location, bedrooms, bathrooms, number of units, property description, total monthly payment, historical income amount for each unit, etc. This data may then be used by the application program to calculate the personal liability for the homebuyer depending on which unit they are living within in relation to rental income for the other units associated with the property.

In some embodiments, the user module 212 facilitates the creation of a user account for the application system. The user module 212 may allow the user to create a user profile which includes user information, user-associated property information, property criteria, favorite properties, income amount, personal liability preferences, comfortable monthly budget, etc.

In some embodiments, the allowable mortgage calculation module 214 is in operable communication with the application program to calculate the maximum mortgage amount that the homebuyer qualifies for. The maximum allowable mortgage amount may be calculated using a percentage of the homebuyers monthly net income (often between 30-50% of the homebuyers monthly net income). For example, if the homebuyer has a monthly net income of $10,000 per month, a lender may decide that they are comfortable with the homebuyer having a monthly mortgage amount equivalent to 43% of their monthly net income (see FIG. 13). This results in a maximum monthly mortgage amount of $4,300 per month. This amount then allows the system to show properties for which the homebuyer qualifies for and can afford. However, because the system is configured to aid multi-family property buyers in purchasing a property wherein the mortgage amount is at least partially paid for by renters of other units, the system then utilizes the allowable offer calculator module 218 to determine suitable multi-family properties for which they qualify.

In some embodiments, the display module 216 is configured to display one or more graphic user interfaces, including, e.g., one or more user interfaces, one or more consumer interfaces, one or more video presenter interfaces, etc. In some embodiments, the display module 216 is configured to temporarily generate and display various pieces of information in response to one or more commands or operations. The various pieces of information or data generated and displayed may be transiently generated and displayed, and the displayed content in the display module 216 may be refreshed and replaced with different content upon the receipt of different commands or operations in some embodiments. In such embodiments, the various pieces of information generated and displayed in a display module 216 may not be persistently stored.

In some embodiments, the allowable offer calculation module 218 is in operable communication with the application program to receive multi-family property information and generate a maximum allowable offer. This is accomplished by the system reading which unit(s) on a particular property are the largest unit based on the bedroom count for the unit. The allowable offer calculation module 218 then adds up the total rental income for the smaller units and adds (75%) of the rental income from other units into the user's income. This additional rental income is what allows homebuyers of multi-family property to qualify for higher mortgage/loan amounts than single family homes (as single family homes do not increase a homebuyer's income). This allows the system to generate & display the complete/entire list of multi-family property homes that a homebuyer could potentially purchase, based on the user's income and the income of each individual multi-family property on the market. For properties with one or more vacant units, the system will pull in the estimated rental data for the vacant unit(s) from an API service such as Rentometer.com.

In some embodiments, the application program connects with a third party to retrieve current rental income data for each individual unit. This allows the user to compare the current rental income that the units produce with the units should produce based on today's present market rents.

In some embodiments, the personal liability calculation module 220 is used to calculate the monthly total that the homebuyer will pay after collecting the rental income from the other units in the property (depending on which unit the buyer chooses to live in and which unit(s) the buyer will rent to others). This is why there is a unique personal liability that corresponds to each unit of a given property. This information is automatically displayed in the user interface to display to the user the amount they will be liable for each month as a component of the mortgage, assuming each unit has been rented at the indicated price.

FIG. 3 illustrates a block diagram of databases and application program including a criteria of user database 300, property database 310, favorite properties database 320, and vendor to user success database 330.

The criteria of user database 300 stores user criteria for the properties they are searching. This may include location, list price maximum/minimum, unit maximum/minimum, number of bedrooms, number of bathrooms, down payment amount, among other property details known in the arts. The property database 310 stores property information for each property available for purchase. The property database 310 may be in communication with the MLS or other listing databases to permit the user to search for available properties, especially those matching their user criteria. The favorite properties database 320 stores properties which the user has “favorited” such as by selecting a favorite button on the property listing, or otherwise indicating interest in the property. This allows the user to efficiently find properties they are interested in.

The vendor to user success database 330 is a database that contains important concepts & aspects of real estate investing, as well as the various contacts/vendors a user would need to know in order to make the most of the investment. For example, multi-family real estate has incredible tax benefits such as accelerated depreciation via “cost segregation.” To fully take advantage of these tax benefits, a homebuyer must know 1) a cost segregation firm, and 2) CPA and/or Tax Attorney (especially when a user has “Real Estate Professional Status). Other tax benefits are the “1031 exchange,” which is performed by a vendor called a “qualified intermediary.” These types of concepts & contacts are not widely known to the homebuyer who is new to multi-family, so the vendor to user success database was created to educate the consumer of various concepts, as well as a place where they can find the appropriate contacts related to the various services. Other important vendors would be real estate agents & mortgage brokers who specialize in residential multi-family real estate, property managers, etc.

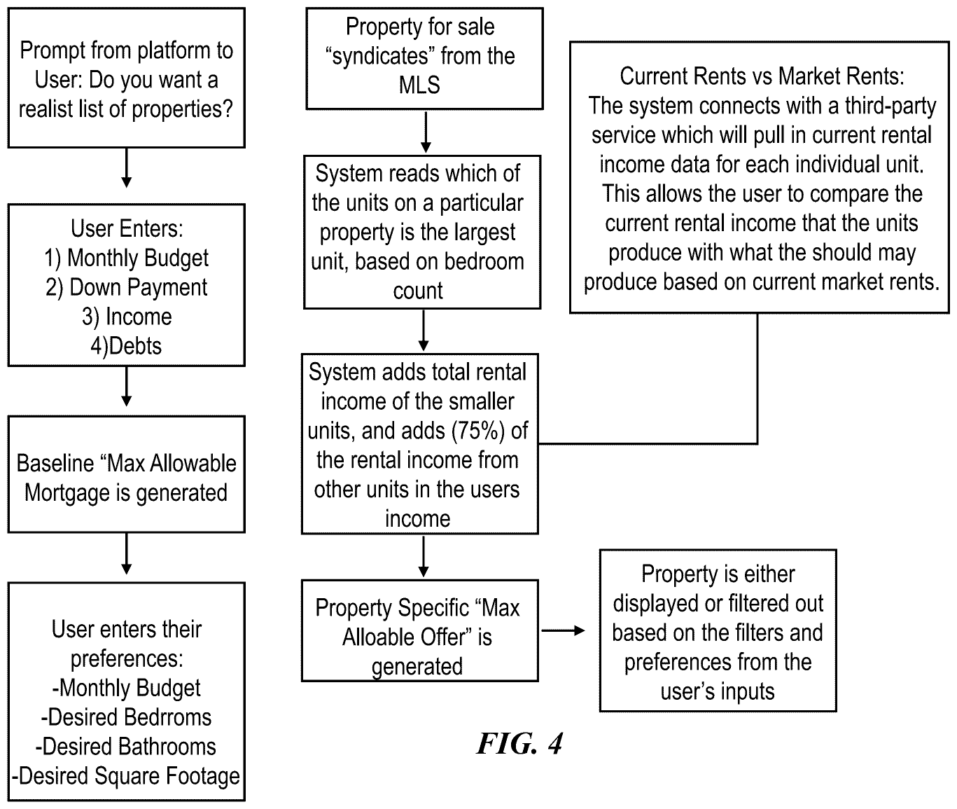

FIG. 4 illustrates a flowchart of the property display process. The system initially displays all available residential multi-family properties regardless of user criteria. The system can then filter and display appropriate properties based on information the user enters as part of a user criteria. Information may include a monthly budget, down payment amount available, income, and debts. A baseline maximum allowable mortgage is generated, and the user enters their preferences (e.g., comfortable monthly budget, desired bedrooms, desired bathrooms, desired square footage, etc.). A listing service (e.g., MLS) permits the system to read which of the units on a particular property is the largest unit (based on the bedroom count). The system then adds up the total rental income of the smaller units and adds (75%) of this rental income from other units into the user's income to calculate the maximum allowable offer for the user. The property is then either displayed, segmented, filtered out based on the filters and preferences from the user's criteria information. Segments may be defined as MAO>List Price and MAO<List Price. It is to be understood that the MOA is driven by the rental income of the smaller units of a given property if the assumption is made that the buyer will be moving into the largest unit.

In some embodiments, the current rent compared with the market rent is determined by the system. The application program connects to a third-party rent calculation/estimation service which pulls current rental income data for each individual unit in the property. This allows the user to compare the current rental income produced by the units with what the units should produce based on current market data. For both house hackers and investors (non-owner occupying homebuyers) alike, the system allows the user to compare the existing rental rate (“as-is” rental rate) versus a current market rental rate (potential rental rate). This may be especially useful if a current tenant is paying an existing rental rate below the current market rental rate, since the system displays the potential rental rate, the buyer may receive if a new tenant moves into the unit.

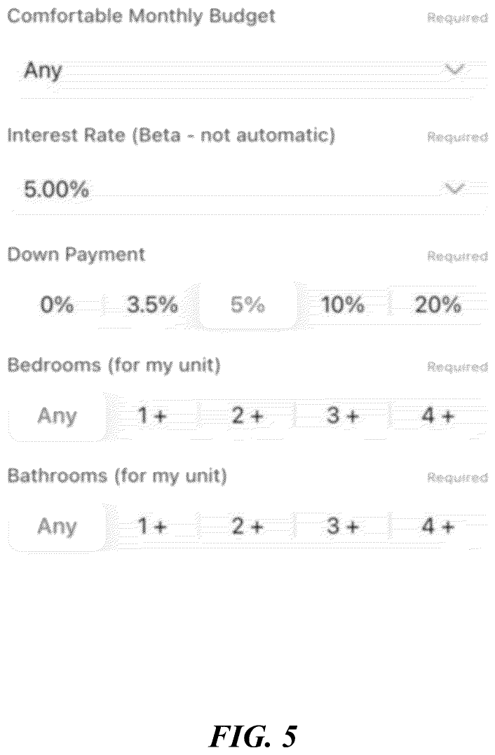

FIG. 5 illustrates a screenshot of the property search interface. The property search interface allows the user to input at least a portion of their user criteria. This may include their comfortable monthly budget amount, interest rate, down payment, bedrooms, bathrooms, and other property associated information.

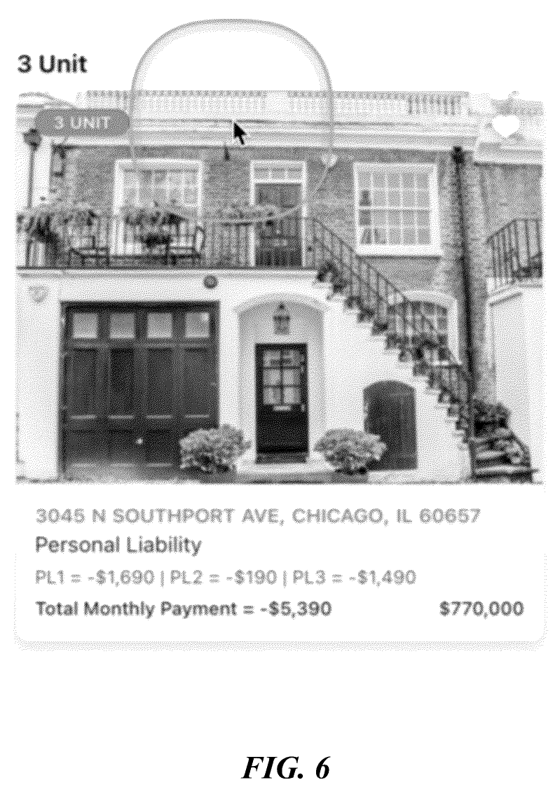

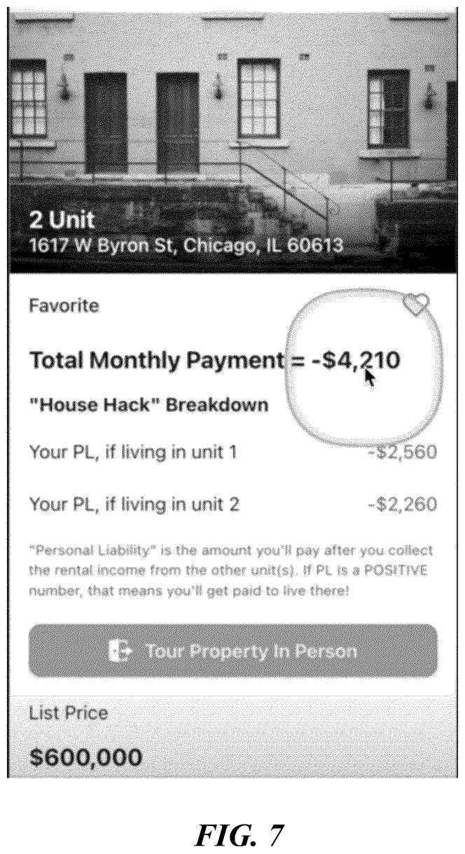

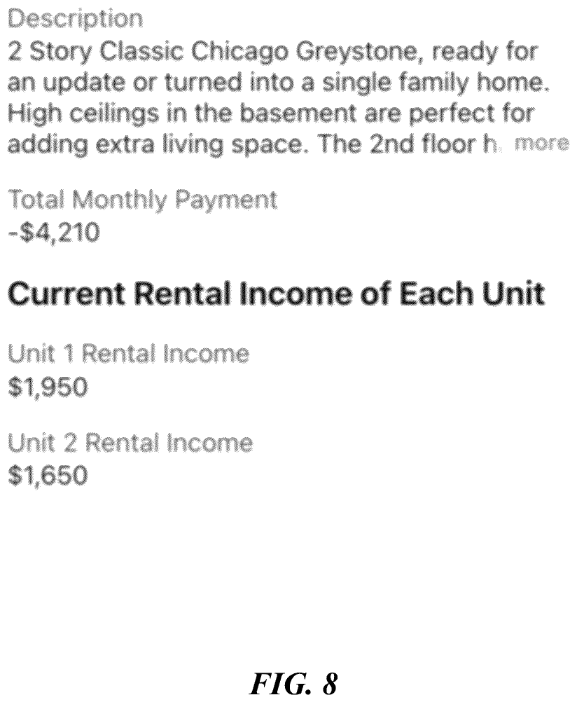

FIG. 6 illustrates a screenshot of the property display interface which may include images of the property, number of units, personal liability amounts, total monthly payment, list price, and other property associated information. FIG. 7 illustrates a screenshot of the property payment details interface. This property payment details interface illustrates a total monthly payment as well as a house-hack breakdown indicating the personal liability depending on which unit the user decides to live in. FIG. 8 illustrates a screenshot of the property details interface wherein the property description, total monthly payment, and rental income by unit is displayed.

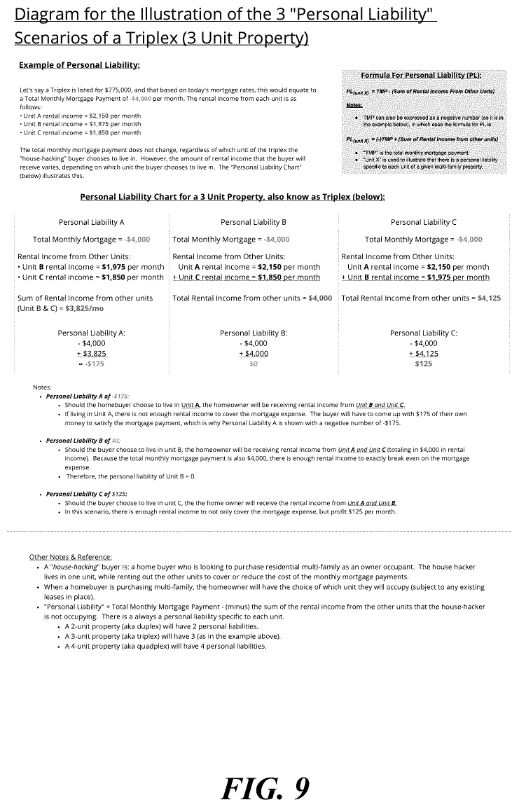

FIG. 9 illustrates a table displaying an exemplary personal liability calculation chart for a 3-unit property. In the illustrated example, a triplex is listed for $775,000 equating to a total monthly mortgage payment of $4000 per month. The total monthly mortgage payment does not change, regardless of which unit of the triplex the buyer chooses to live in. However, the amount of rental income that the buyer will receive varies, depending on which unit the buyer chooses to live in as illustrated by the personal liability chart illustrated in FIG. 9.

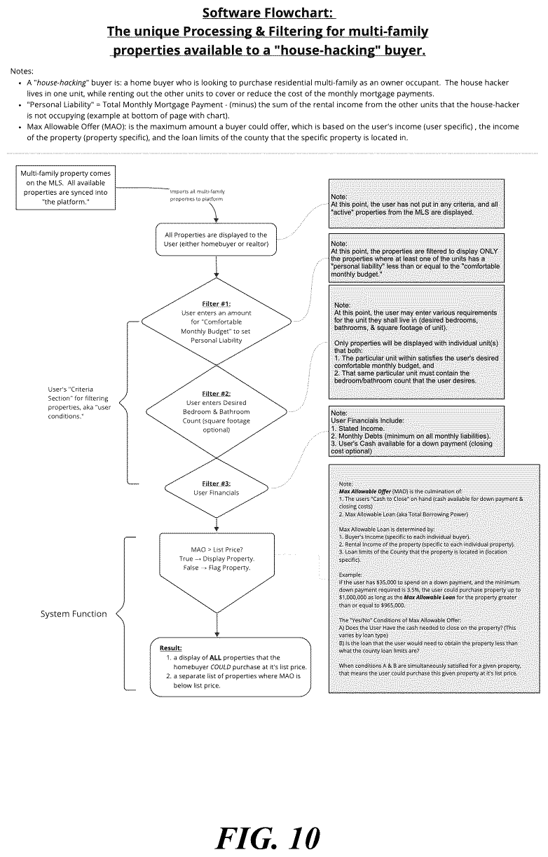

FIG. 10 illustrates a flowchart of the process for further filtering and displaying available properties. Multi-family properties are provided by the MLS and are synced to the platform. Users may enter a first filter such as, for example, an amount for a “comfortable monthly budget” to set personal liability. A second filter may be input such as, for example, number(s) of desired bedroom(s) and bathroom(s) and/or a square footage. A third filter may be input such as, for example, the user's financial information. The system then determines if the maximum allowable offer is greater than a list price for a given property. If the buyer's maximum allowable offer is greater than the list price, the property is displayed. If the buyer's maximum allowable offer is less than the list price, the property is hidden, unless the user decides to view properties where their MAO is within a certain percentage under list price. This percentage can be set by the user. This would be helpful when there is a property listed for $900,000 but the buyer's MAO for this property is $899,999. This results in a display of all properties the user could potentially purchase which is determined at least in part using the personal liability chart formula displayed in FIG. 9.

In some embodiments, the system may be utilized to calculate rental amounts if the buyer is not an occupant in one of the units of the property they are viewing. In such, the system will provide rental amounts for each unit and/or an amount associated with a monthly/yearly profit for the property if the property is rented at the indicated estimated rental amounts.

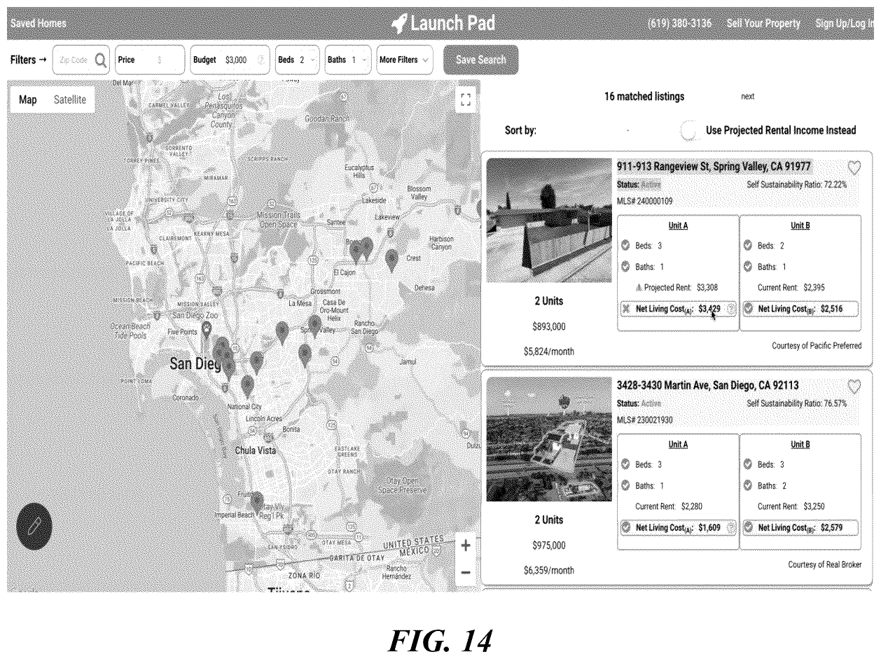

In reference to FIG. 14, a screenshot of the property listings and search interface is shown which includes a map illustrating various properties which are available on the market. The map may also pinpoint locations corresponding to properties which have been matched in a search. The user may search for properties using various property metrics which can include a location, a budget, a number of beds, a number of baths, etc. The net living cost (i.e., the personal liability) is displayed for each unit which comprises the property. This information is calculated using the technique described hereinabove.

In this disclosure, the various embodiments are described with reference to the flowchart illustrations and/or block diagrams of methods, apparatus (systems), and computer program products. Those skilled in the art would understand that each block of the flowchart illustrations and/or block diagrams, and combinations of blocks in the flowchart illustrations and/or block diagrams, can be implemented by computer readable program instructions. The computer readable program instructions can be provided to a processor of a general purpose computer, special purpose computer, or other programmable data processing apparatus to produce a machine, such that the instructions, which execute via the processor of the computer or other programmable data processing apparatus, create means for implementing the functions or acts specified in the flowchart and/or block diagram block or blocks. The computer readable program instructions can be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks. The computer readable program instructions can be loaded onto a computer, other programmable data processing apparatus, or other device to cause a series of operational acts to be performed on the computer, other programmable apparatus, or other device to produce a computer implemented process, such that the instructions that execute on the computer, other programmable apparatus, or other device implement the functions or acts specified in the flowchart and/or block diagram block or blocks.

In this disclosure, the block diagrams in the Figures illustrate the architecture, functionality, and operation of possible implementations of systems, methods, and computer program products according to the various embodiments. Each block in the flowchart or block diagrams can represent a module, segment, or portion of instructions, which comprises one or more executable instructions for implementing the specified logical function(s). In some embodiments, the functions noted in the blocks can occur out of the order noted in the Figures. For example, two blocks shown in succession can, in fact, be executed concurrently or substantially concurrently, or the blocks can sometimes be executed in the reverse order, depending upon the functionality involved. In some embodiments, each block of the block diagrams and/or flowchart illustration, and combinations of blocks in the block diagrams and/or flowchart illustration, can be implemented by a special purpose hardware-based system that performs the specified functions or acts or carry out combinations of special purpose hardware and computer instructions.

In this disclosure, the subject matter has been described in the general context of computer- executable instructions of a computer program product running on a computer or computers, and those skilled in the art would recognize that this disclosure can be implemented in combination with other program modules. Generally, program modules include routines, programs, components, data structures, etc. that perform particular tasks and/or implement particular abstract data types. Those skilled in the art would appreciate that the computer-implemented methods disclosed herein can be practiced with other computer system configurations, including single-processor or multiprocessor computer systems, mini-computing devices, mainframe computers, as well as computers, hand-held computing devices (e.g., PDA, phone), microprocessor-based or programmable consumer or industrial electronics, and the like. The illustrated embodiments can be practiced in distributed computing environments where tasks are performed by remote processing devices that are linked through a communications network. Some embodiments of this disclosure can be practiced on a stand-alone computer. In a distributed computing environment, program modules can be located in both local and remote memory storage devices.

In this disclosure, the terms “component,” “system,” “platform,” “interface,” and the like, can refer to and/or include a computer-related entity or an entity related to an operational machine with one or more specific functionalities. The disclosed entities can be hardware, a combination of hardware and software, software, or software in execution. For example, a component can be a process running on a processor, a processor, an object, an executable, a thread of execution, a program, and/or a computer. By way of illustration, both an application running on a server and the server can be a component. One or more components can reside within a process and/or thread of execution and a component can be localized on one computer and/or distributed between two or more computers. In another example, respective components can execute from various computer readable media having various data structures stored thereon. The components can communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software or firmware application executed by a processor. In such a case, the processor can be internal or external to the apparatus and can execute at least a part of the software or firmware application. As another example, a component can be an apparatus that provides specific functionality through electronic components without mechanical parts, wherein the electronic components can include a processor or other means to execute software or firmware that confers at least in part the functionality of the electronic components. In some embodiments, a component can emulate an electronic component via a virtual machine, e.g., within a cloud computing system.

The phrase “application” as is used herein means software other than the operating system, such as Word processors, database managers, Internet browsers and the like. Each application generally has its own user interface, which allows a user to interact with a particular program. The user interface for most operating systems and applications is a graphical user interface (GUI), which uses graphical screen elements, such as windows (which are used to separate the screen into distinct work areas), icons (which are small images that represent computer resources, such as files), pull-down menus (which give a user a list of options), scroll bars (which allow a user to move up and down a window) and buttons (which can be “pushed” with a click of a mouse). A wide variety of applications is known to those in the art.

The phrases “Application Program Interface” and API as are used herein mean a set of commands, functions and/or protocols that computer programmers can use when building software for a specific operating system. The API allows programmers to use predefined functions to interact with an operating system, instead of writing them from scratch. Common computer operating systems, including Windows, Unix, and the Mac OS, usually provide an API for programmers. An API is also used by hardware devices that run software programs. The API generally makes a programmer's job easier, and it also benefits the end user since it generally ensures that all programs using the same API will have a similar user interface.

The phrase “central processing unit” as is used herein means a computer hardware component that executes individual commands of a computer software program. It reads program instructions from a main or secondary memory, and then executes the instructions one at a time until the program ends. During execution, the program may display information to an output device such as a monitor.

The term “execute” as is used herein in connection with a computer, console, server system or the like means to run, use, operate or carry out an instruction, code, software, program and/or the like.

In this disclosure, the descriptions of the various embodiments have been presented for purposes of illustration and are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein. Thus, the appended claims should be construed broadly, to include other variants and embodiments, which may be made by those skilled in the art.

What is claimed is:

1. A system for multi-family property real estate search and analysis, the system comprising:
at least one user computing device in operable connection with a user network; and
an application server in operable communication with the user network, the application server configured to host an application system for providing a search engine and for providing investment analysis related to residential multi-family properties, the application system having a user interface module for providing access to the application system through the user computing device, the application program to calculate a personal liability informed by a plurality of rental data for units rented by a third-party.

2. The system of claim 1, further comprising an allowable mortgage calculation module to determine a maximum mortgage amount for which the user qualifies, specific to each property.

3. The system of claim 1, further comprising an allowable offer calculation module to generate a maximum allowable offer for each individual property.

4. The system of claim 1, further comprising a personal liability calculation module to calculate a personal liability for each individual unit of each property for the user based on amounts received for each rental unit.

5. The system of claim 1, further comprising a criteria of user database to store a plurality of user criteria including at least one of the following: a location, a unit maximum/minimum, a number of bedrooms, a number of bathrooms, a down payment amount, and a monthly budget.

6. A system for analyzing multi-family property real estate using multiple parameters, the system comprising:
at least one user computing device in operable connection with a user network;
an application server in operable communication with the user network, the application server configured to host an application system for providing a search engine and for providing investment analysis related to residential multi-family properties;
a property module in operable communication with a property details and search interface to display a plurality of multi-family properties;
an allowable mortgage calculation module to determine a maximum mortgage amount for which the user qualifies, wherein the maximum mortgage amount is specific to each property;
an allowable offer calculation module to generate a maximum allowable offer for each individual property;
a personal liability calculation module to calculate a personal liability cost for each individual unit of each multi-family property for the user based on amounts received in rent for each rental unit comprising the multi-family property and a mortgage amount; and
the application system having a user interface module for providing access to the application system through the user computing device, the application program to calculate a personal liability informed by a plurality of rental data for units rented by a third-party,
wherein the property details and search interface displays each multi-family property which the user qualifies to purchase based on the plurality of rental data, the amounts received in rent for each rental until comprising each multi-family property, and the maximum mortgage amount.

7. The system of claim 6, further comprising a criteria of user database to store a plurality of user criteria including at least one of the following: a location, a unit maximum/minimum, a number of bedrooms for each rental unit, a number of bathrooms for each rental unit, a down payment amount, and a monthly budget.

8. The system of claim 6, wherein the property details and search interface further comprises the personal liability cost for each unit and wherein the personal details and search interface displays an indicator representing a qualification status for each rental unit.

9. The system of claim 6, wherein the property details and search interface includes provides an input field to permit the user to input a maximum budget, wherein the maximum budget is utilized by the personal liability calculation module to determine the personal liability cost for each rental unit.

10. The system of claim 6, wherein the property details and search interface displays a list of rental units comprising the multi-family property.

11. The system of claim 6, wherein the property details and search interface provides a filter to permit the user to search using a location, a price, a maximum budget, a number of beds, and a number of baths.

12. The system of claim 6, wherein the computer system further comprises a processor to perform the following steps:
receiving, via a user input, a monthly budget, a down payment amount, an income amount, and a debt amount;
generating, via the allowable mortgage calculation module, the maximum mortgage amount;
inputting, via the user, a plurality of user inputs including at least one of the following:
the monthly budget amount, a desired number of bedrooms, a desired number of bathrooms, and a desired square footage;
analyzing, via the property module, a third-party database to identify and aggregate one or more multi-family properties which meet the plurality of user inputs;
generating, via the allowable offer calculation module, the maximum allowable offer for each of the multi-family properties; and
filtering each of the multi-family properties to display the multi-family properties which the user qualifies for based on the plurality of user inputs and the maximum allowable offer.

13. The system of claim 12, wherein a third-party database provides a plurality of rental property data to permit the comparison of a current rent amount versus a market rate amount.

14. A method for analyzing multi-family property real estate using multiple parameters, the method comprising the steps of:
receiving, via one or more user inputs, a monthly budget, a down payment amount, an income amount, and a debt amount;
generating, via the allowable mortgage calculation module, the maximum mortgage amount;
inputting, via the user, a plurality of user inputs including at least one of the following: the monthly budget amount, a desired number of bedrooms for each rental unit, a desired number of bathrooms for each rental unit, and a desired square footage;
analyzing, via the property module, an MLS to identify and aggregate one or more multi- family properties which meet the plurality of user inputs;
generating, via the allowable offer calculation module, the maximum allowable offer for each of the multi-family properties; and
filtering each of the multi-family properties to display the multi-family properties which the user qualifies for based on the plurality of user inputs and the maximum allowable offer.

15. The method of claim 14, further comprising a display module to provide a property details and search interface.

16. The method of claim 15, wherein the property details and search interface displays each multi-family property which the user qualifies to purchase based on the plurality of rental data, the amounts received in rent for each rental until comprising each multi-family property, and the maximum allowable offer amount.

17. The method of claim 16, further comprising a personal liability cost for each unit and wherein the personal details and search interface displays an indicator representing a qualification status for each rental unit.

18. The method of claim 17, further comprising a plurality of selectable filters to receive the plurality of user inputs.

19. The method of claim 18, further comprising a map interface to display each multi- family property.

20. The method of claim 19, wherein a communication module enables the communication with a third-party data platform including a third-party database.
